(19) United States
(12) Patent Application Publication
(10) Pub. No.: US 2015/0247395 A1
(43) Pub. Date: Sep. 3, 2015

(54) Free-Flowing Aqueous Compositions And Processes For Enhancing The Production Rate Of Mineral Oil And/Or Natural Gas From An Underground Deposit Comprising Mineral Oil And/Or Natural Gas

(71) Applicant: WINTERSHALL HOLDING GMBH, Kassel (DE)

(72) Inventor: Vladimir Stehle, Kassel (DE)

(73) Assignee: WINTERSHALL HOLDING GMBH, Kassel (DE)

(21) Appl. No.: 14/430,246

(22) PCT Filed: Sep. 25, 2013
(86) PCT No.: PCT/EP2013/070011

§ 371 Date: Mar. 23, 2015

(30) Foreign Application Priority Data
Sep. 27, 2012 (EP) 12186269.2
Jun. 4, 2013 (EP) 13170403.3

(51) Int. Cl. E21B 43/24; E21B 36/00; C09K 8/90

(52) U.S. Cl. CPC E21B 43/24; C09K 8/905; E21B 36/008

(57) ABSTRACT

The present invention relates to free-flowing aqueous compositions and to a process for enhancing the production rate of mineral oil and/or natural gas from an underground deposit which comprises mineral oil and/or natural gas, and into which at least one well has been sunk, the latter being in contact with the underground deposit through at least one perforation region.

### CROSS REFERENCE TO RELATED APPLICATIONS

This is the National Phase entry of International Patent Application No. PCT/EP2013/070011, filed Sep. 25, 2013, which claims priority to European Patent Application No. 12186269.2, filed Sep. 27, 2012, and European Patent Application No. 13170403.3, filed Jun. 4, 2013, the disclosures of which are incorporated herein by reference in their entireties.

### FIELD OF THE INVENTION

The present invention relates to free-flowing aqueous compositions and to a process for enhancing the production rate of mineral oil and/or natural gas from an underground deposit which comprises mineral oil and/or natural gas, and into which at least one well has been sunk, the latter being in contact with the underground deposit through at least one perforation region.

### BACKGROUND OF THE INVENTION

In natural mineral oil and/or natural gas deposits, mineral oil and/or natural gas generally occurs in cavities of porous reservoir rocks which are closed off from the surface of the earth by impervious overlying strata. In addition to mineral oil and/or natural gas, an underground deposit generally further comprises water with a greater or lesser salt content (also called formation water). The cavities may be very fine cavities, capillaries, pores or the like, for example those having a diameter of only approx. one micrometer. The underground deposit may additionally also have regions with pores of greater diameter, fissures and/or natural faults.

In the production of mineral oil and/or natural gas from underground deposits, the production rate depends to a high degree on the permeability of the reservoir rocks and rock strata which adjoin the well. The more permeable these rock strata or the reservoir rocks are, the higher the production rates of mineral oil and/or natural gas achieved. High production rates are necessary in order that operation of an underground deposit is economically viable. As a result of a well being sunk into a productive stratum of an underground deposit comprising mineral oil and/or natural gas, mineral oil and/or natural gas at first arrives at the surface of the earth in an eruptive manner due to the natural deposit pressure. This phase of the production of mineral oil and/or natural gas is also referred to by the person skilled in the art as primary production. Under adverse deposit conditions, for example a high viscosity of the mineral oil, rapidly declining deposit pressure or high flow resistances in the reservoir rocks, eruptive production generally ceases rapidly. Primary production produces an average of not more than two to ten percent of the mineral oil and/or natural gas originally present in the underground deposit.

Both in the course of development and during the production of mineral oil and/or natural gas from an underground deposit, there may additionally be a reduction in the permeability of the reservoir rock and of the rock strata adjoining the well. As a result of the decrease in the permeability, the production rate of mineral oil and/or natural gas from the underground deposit decreases significantly, or it may cease completely.

In order to improve hydrodynamic communication between the well and the underground deposit comprising mineral oil and/or natural gas, the rock surrounding a section of the well is typically fissured. In order to enhance the flow of fluids (especially mineral oil and/or natural gas) into and/or out of the underground deposit, it is common practice to subject parts of the underground formation to hydraulic fracturing. Hydraulic fracturing (or fissuring of an underground rock stratum in a deposit) is understood to mean the occurrence of a fracture event in the rock surrounding the well as a result of the hydraulic action of a liquid or gas pressure on the rock of the underground deposit.

In the last few years, hydraulic fracturing has become ever more important. This involves using a fracking fluid comprising water, gel formers and optionally crosslinkers. In the case of water-based hydraulic fracturing, a fracking fluid is injected under high pressure through a well into the rock stratum to be fractured or fissured. The fracking fluid is pumped into the rock stratum to be fractured or fissured at a pressure sufficient to divide or fracture the rock strata. This widens natural fissures and cracks present, which have been formed in the course of evolution of the underground rock stratum and in the event of subsequent tectonic movements, and produces new cracks, crevices and fissures. Proppants such as sand may be added to the fracking fluid.

There have additionally been descriptions of processes for producing fissures or cracks in the rock surrounding a well, in which explosives are used to bring about the fracking event.

The section of the well where the surrounding rock has fissures or cracks is also referred to as the perforation region.

After the formation of the perforation region in the well, this region can be stabilized. This is typically accomplished by the introduction of pipes having orifices into the perforation region of the well. The orifices of the pipes enable good hydrodynamic communication between the underground deposit and the well.

The well may either be a production well or an injection well. A production well is generally understood to mean the well through which the mineral oil and/or natural gas is produced. An injection well is typically understood to mean the well through which a fluid medium is injected into the underground deposit, in order to shift mineral oil and/or natural gas from the injection well in the direction of the production well.

During the operating phase of an underground deposit comprising mineral oil and/or natural gas, high-viscosity substances frequently accumulate in the fissured rock surrounding the perforation region. The high-viscosity substances may be paraffins, high-viscosity mineral oil and bitumen (asphaltenes). These high-viscosity substances block the rock surrounding the perforation region. As a result, the production rate of mineral oil and/or natural gas from the underground deposit declines significantly. In exceptional cases, the production of mineral oil and/or natural gas may even cease completely.

In addition, in the case of sinking of wells, both in the case of production and injection wells, during the drilling process, and also in the course of the subsequent processes for stabilizing the well, for example cementing processes, slurry can be formed from the fissured rock strata surrounding the perforation region of the well. In addition, there is a change in the stress pressure and deformation state in the rock surrounding the well. The effect of this is generally that rock zones having a higher density and lower permeability form in a cylinder around the well. This likewise leads to a reduction in the production rate of mineral oil and/or natural gas from the underground deposit.

In order to counteract the reduction in the permeability of the perforation region, the prior art describes various methods. The best-known methods include purging of the well with hot water or with steam. In addition, there have been descriptions of the use of mixtures which generate large volumes of gas in the underground deposit. These mixtures react exothermically to form hot gases, which leads to a pressure rise in the well and in the adjoining rock strata. This allows high-viscosity substances to be leached out of the rock surrounding the perforation region. The pressure wave can additionally form further cracks and fissures in the rock surrounding the perforation region.

RU 2168008 describes a process in which a liquid composition comprising an oxidizing agent and a carbon compound is injected into a well. The oxidizing agent used in the process of RU 2168008 is ammonium nitrate. The carbon compound described is urea. After the injection of the liquid composition into the well, the exothermic reaction of the liquid composition is initiated. The liquid composition is detonated by an electrical detonator. The ammonium nitrate and the urea react in an exothermic reaction to form water vapor, nitrogen and carbon dioxide. The hot gas mixture which forms in this reaction dissolves deposits which are blocking the rock surrounding the perforation region. This achieves an increase in the production rate of mineral oil and/or natural gas from the underground deposit. The process described in RU 2168008 has the disadvantage that the liquid composition can mix with the formation water present in the well. This leads to a change in the concentration of the free-flowing composition, as a result of which the properties of the liquid composition can change. The dilution with the formation water present in the well can change the concentration of the liquid composition to such a degree that the exothermic reaction of the liquid composition is subsequently no longer ensured.

The relatively low viscosity of the composition described in RU 2168008 can additionally result in sedimentation of the ammonium nitrate used as the oxidizing agent or of the urea used as the carbonaceous component. This likewise complicates the reliable initiation of the exothermic reaction. The liquid composition described in RU 2168008 is therefore unreliable, since dilution with formation water or sedimentation of the components means that reliable initiation of the exothermic reaction is not always ensured.

RU 2456440 likewise describes a liquid composition which can generate gas in the well. The liquid composition of RU 2456440 comprises hydrocarbons and an oxidizing agent. The liquid composition according to RU 2456440 comprises cellulose ether to increase the viscosity. It is known that cellulose ether, when the temperature is increased, leads to an abrupt rise in the viscosity of the liquid composition. The cellulose ether used as a thickener can slow the sedimentation of the oxidizing agent. The liquid composition described in RU 2456440 has the disadvantage that, when used in wells comprising formation water having a high salt content, it likewise does not work reliably. The salt content of the formation water can alter the rheological properties of the compositions described in RU 2456440. The high salt content leads to a distinct decrease in the viscosity of the liquid composition described in RU 2456440. This can again result in mixing of the liquid composition with the formation water in the well. The dilution of the liquid composition which occurs as a result means that the initiation of the exothermic reaction is not always ensured. The decrease in viscosity which occurs, especially in wells comprising formation water having a high salt content, can additionally result in sedimentation of the oxidizing agents. The free-flowing composition according to RU 2456440 is therefore likewise unsuitable, especially for wells comprising formation water having a high salt content.

RU 2109127 and U.S. Pat. No. 4,867,238 likewise describe liquid compositions for increasing the production rate of mineral oil and/or natural gas from underground deposits. These processes involve injecting highly concentrated solutions of hydrogen peroxide into the well. The exothermic decomposition of hydrogen peroxide is subsequently initiated by means of catalysts, for example manganese oxide. The liquid compositions described in RU 2109127 and U.S. Pat. No. 4,867,238 likewise have the disadvantage that they are diluted rapidly in wells comprising formation water. As a result of the change in concentration which occurs, reliable initiation of the exothermic decomposition of hydrogen peroxide is not always ensured. The above-described processes are therefore unsuitable for increasing the production rates of mineral oil and/or natural gas from underground deposits where the wells comprise formation water.

There was thus a need for improved compositions suitable for enhancing the production rate of mineral oil and/or natural gas from underground deposits, especially those comprising formation water. In addition, there was a need to provide improved processes for enhancing the production rate of mineral oil and/or natural gas from underground deposits comprising mineral oil and/or natural gas.

### SUMMARY OF THE INVENTION

It was thus an object of the present invention to provide a free-flowing aqueous composition which has the disadvantages of the compositions described in the prior art only to a reduced degree, if at all, and can be used to enhance the production rate of mineral oil and/or natural gas from an underground deposit comprising mineral oil and/or natural gas. It is a further object of the present invention to provide an improved process for enhancing the production rate of mineral oil and/or natural gas from an underground deposit comprising mineral oil and/or natural gas. The free-flowing aqueous compositions are to be stable against dilution with formation water present in the well. The initiation of the exothermic reaction of the free-flowing aqueous compositions is to be reliably ensured.

### DESCRIPTION OF THE DRAWINGS

FIG. 1A shows a vertical section through an underground deposit which comprises mineral oil and/or natural gas, and into which a quasi-horizontal well has been sunk, with a coil tubing introduced into the region of the well bottom and injection of the tamping composition through the coil tubing. FIG. 1B shows subsequent injection of the free-flowing composition through the same coil tubing into the region of the well bottom. FIG. 10 shows a further tamping composition being injected into the region of the well bottom via the same coil tubing.

FIG. 2A shows a quasi-vertical well with a perforation region with a coil tubing introduced into the region of the well bottom and injection of the tamping composition through the coil tubing. FIG. 2B shows subsequent injection of the free-flowing composition through the same coil tubing into the region of the well bottom. FIG. 2C shows a further tamping composition being injected into the region of the well bottom via the same coil tubing.

### DETAILED DESCRIPTION

This object is achieved in accordance with the invention by a free-flowing aqueous composition comprising
at least one oxidizing agent (O) selected from the group consisting of ammonium nitrate, ammonium perchlorate, sodium perchlorate, potassium perchlorate and hydrogen peroxide,
optionally at least one reducing agent (R) selected from the group consisting of urea, polyalkylene glycol and glycerol, and
a glucan (G) having a β-1,3-glycosidically linked main chain and side groups β-1,6-glycosidically bonded thereto.

The free-flowing aqueous composition can be made to react exothermically by means of a detonator, causing the oxidizing agent (O) to react with the reducing agent (R) optionally present, with evolution of gas and heat. If the free-flowing aqueous composition does not comprise any reducing agent (R), the oxidizing agent (O) reacts exothermically with decomposition, evolving gas and heat. The evolution of heat which occurs in the exothermic reaction or exothermic decomposition, together with the evolution of gas which occurs, removes deposits of high-viscosity substances from the fissured rock surrounding the perforation region. The pressure of the gas evolution can additionally form new cracks and fissures in the rock surrounding the perforation region.

The inventive free-flowing aqueous composition has the advantage that the initiation of the exothermic reaction can be reliably ensured. The free-flowing aqueous compositions also enable an enhancement of the production rate of mineral oil and/or natural gas from underground deposits into which directional wells have been sunk. The inventive free-flowing aqueous compositions can additionally be used advantageously in wells comprising formation water having a high salt content.

The production rates are enhanced predominantly as a result of the treatment of the well with high temperatures and high gas pressure. The treated well may be unlined or lined, at least one section being perforated in the case of a lined well. The area of use of the free-flowing compositions is, for example, in dense gas and oil deposits and wells with a contaminated area close to the well. The preferred areas of use are long quasi-horizontal production and injection wells.

### Free-Flowing Aqueous Composition

The free-flowing aqueous composition comprises at least one oxidizing agent (O) selected from the group consisting of ammonium nitrate, ammonium perchlorate, sodium perchlorate, potassium perchlorate and hydrogen peroxide. The free-flowing aqueous composition may comprise exactly one oxidizing agent (O), but it is also possible that the free-flowing aqueous composition comprises two or more oxidizing agents (O). Hereinafter, the term “oxidizing agent (O)” comprises exactly one oxidizing agent (O) and mixtures of two or more oxidizing agents (O).

The free-flowing aqueous composition optionally comprises at least one reducing agent (R) selected from the group consisting of urea, polyalkylene glycol and glycerol. Thus, the free-flowing aqueous composition may comprise exactly one reducing agent (R), but it is also possible that the free-flowing aqueous composition comprises a mixture of two or more reducing agents (R). Hereinafter, the term “reducing agent (R)” comprises exactly one reducing agent (R) and mixtures of two or more reducing agents (R).

If the free-flowing aqueous composition comprises a mixture of two or more oxidizing agents (O), the two or more oxidizing agents (O) may be selected from the group consisting of ammonium nitrate, ammonium perchlorate, sodium perchlorate, potassium perchlorate and hydrogen peroxide. It is also possible that the free-flowing aqueous composition, as well as the oxidizing agents (O) detailed above, comprises further oxidizing agents (O) other than these.

If the free-flowing aqueous composition comprises two or more reducing agents (R), these may be selected from the group consisting of urea, polyalkylene glycol and glycerol. However, it is also possible that the mixture of two or more reducing agents (R), as well as the reducing agents (R) detailed above, comprises further reducing agents.

In a preferred embodiment, the free-flowing aqueous composition comprises 10 to 80% by weight of at least one oxidizing agent (O), 0 to 80% by weight of at least one reducing agent (R), 0.05 to 1% by weight of glucan (G) and 5 to 89.95% by weight of water, based in each case on the total weight of the free-flowing aqueous composition, where the sum of the individual components adds up to 100% by weight.

The present invention thus also provides a free-flowing aqueous composition which comprises
10 to 80% by weight of at least one oxidizing agent (O),
0 to 80% by weight of at least one reducing agent (R),
0.05 to 1% by weight of glucan (G) and
5 to 89.95% by weight of water,
   based in each case on the total weight of the free-flowing aqueous composition, and the sum of the individual components adds up to 100% by weight.

In a preferred embodiment, the free-flowing aqueous composition comprises at least one reducing agent (R). The free-flowing aqueous composition preferably comprises 10 to 80% by weight of at least one oxidizing agent (O), 10 to 80% by weight of at least one reducing agent (R), 0.05 to 1% by weight of glucan (G) and 5 to 79.95% by weight of water, based in each case on the total weight of the free-flowing aqueous composition. The present invention thus also provides a free-flowing aqueous composition which comprises
10 to 80% by weight of at least one oxidizing agent (O),
10 to 80% by weight of at least one reducing agent (R),
0.05 to 1% by weight of glucan (G) and
5 to 79.95% by weight of water,
   based in each case on the total weight of the free-flowing composition.

In a preferred embodiment, the free-flowing aqueous composition comprises ammonium nitrate as the oxidizing agent (O) and urea as the reducing agent (R). If the free-flowing aqueous composition comprises ammonium nitrate as the oxidizing agent (O) and urea as the reducing agent (R), the free-flowing aqueous composition comprises preferably 40 to 80% by weight of ammonium nitrate, 10 to 25% by weight of urea, 0.05 to 1% by weight of glucan (G) and 9.95 to 49.95% by weight of water, based in each case on the total weight of the free-flowing aqueous composition. The present invention thus also provides a free-flowing aqueous composition which comprises
40 to 80% by weight of ammonium nitrate,
10 to 25% by weight of urea,
0.05 to 1% by weight of glucan (G) and
9.95 to 49.95% by weight of water,
   based in each case on the total weight of the free-flowing aqueous composition.

The above-described free-flowing aqueous composition comprising ammonium nitrate and urea has the advantage that the constituents thereof are available inexpensively and in large volumes. Urea and ammonium nitrate are additionally very substantially nonhazardous to handle and environmentally safe. This free-flowing aqueous composition reacts exothermically according to the following reaction equation:

3NH₄NO₃+CO(NH₂)₂→8H₂O+4NH₄+CO₂.

The exothermic reaction can be initiated by an electrical or chemical detonator. The exothermic reaction gives rise to large volumes of nitrogen, carbon dioxide and water vapor. In the course of reaction of ammonium nitrate and urea, depending on the concentration of the oxidizing agent (O) and of the reducing agent (R), temperatures exceeding 1000° C. can develop. The hot gas mixture which forms in the thermal reaction leaches deposits of high-viscosity substances out of the surrounding rock adjoining the perforation region. The high-viscosity substances which block the surrounding rock of the perforation zone may, for example, be paraffins, high-viscosity mineral oil or bitumen (also referred to as asphaltenes). The gas mixture formed in the exothermic reaction dissolves these high-viscosity substances, as a result of which the blockages in the rock surrounding the perforation region are removed.

In a further embodiment, the free-flowing aqueous composition comprises ammonium nitrate as the oxidizing agent (O) and polyalkylene glycol as the reducing agent (R). The polyalkylene glycols used may be polyethylene glycols, polypropylene glycols or mixtures of polyethylene glycol and polypropylene glycol. Polyethylene glycols are obtainable by polymerization of ethylene oxide. Polypropylene glycols are obtainable, for example, by the polymerization of propylene oxide or by polycondensation of 1,2-propanediol. Preference is given to the use of polyethylene glycol.

Suitable polyethylene glycols have molar masses in the range from 100 to 5 000 000 g/mol, preferably in the range from 100 to 25 000 g/mol. Polyalkylene glycols, especially polyethylene glycols, have the advantage that they are likewise available inexpensively and in large volumes. Polyalkylene glycols are additionally biodegradable, nontoxic and environmentally safe. If the free-flowing aqueous composition comprises ammonium nitrate as the oxidizing agent (O) and polyalkylene glycol as the reducing agent (R), the free-flowing aqueous composition comprises preferably 40 to 80% by weight of ammonium nitrate, 10 to 25% by weight of polyalkylene glycol, preferably polyethylene glycol, 0.05 to 1% by weight of glucan (G) and 9.95 to 49.95% by weight of water, based in each case on the total weight of the free-flowing aqueous composition. The present invention thus also provides a free-flowing aqueous composition which comprises
40 to 80% by weight of ammonium nitrate,
10 to 25% by weight of polyalkylene glycol,
0.05 to 1% by weight of glucan (G) and
9.95 to 49.95% by weight of water,
   based in each case on the total weight of the free-flowing aqueous composition.

The initiation of the exothermic reaction of a free-flowing aqueous mixture comprising polyalkylene glycol as the reducing agent (R) likewise affords large amounts of heat and volumes of gas. The polyalkylene glycol is decomposed in the process to water and carbon dioxide. The reaction additionally gives rise to nitrogen. The heat released in the exothermic reaction, combined with the gas mixture which forms, removes high-viscosity substances, as described above, from the surrounding rock of the perforation region, which achieves an increase in the production rate of mineral oil and/or natural gas.

It is also possible to use, as the reducing agent (R), a mixture of urea and polyalkylene glycol. The present invention thus also provides a free-flowing composition which comprises 40 to 80% by weight of ammonium nitrate as the oxidizing agent (O) and 10 to 25% by weight of a reducing agent (R), and also 0.05 to 1% by weight of glucan (G), based in each case on the total weight of the free-flowing aqueous composition, the reducing agent (R) comprising 1 to 50% by weight of urea and 1 to 50% by weight of polyalkylene glycol, based in each case on the total weight of the reducing agent (R).

Preference is additionally given to free-flowing aqueous compositions comprising ammonium nitrate as the oxidizing agent (O) and a mixture of urea and glycerol as the reducing agent (R). The free-flowing aqueous composition preferably comprises 40 to 80% by weight of ammonium nitrate, 5 to 25% by weight of urea, 5 to 10% by weight of glycerol, 0.05 to 1% by weight of glucan (G) and 9.95 to 49.95% by weight of water, based in each case on the total weight of the free-flowing aqueous composition. The present invention thus also provides a free-flowing aqueous composition which comprises
40 to 80% by weight of ammonium nitrate,
5 to 25% by weight of urea,
5 to 10% by weight of glycerol,
0.05 to 1% by weight of glucan (G) and
9.95 to 49.95% by weight of water,
   based in each case on the total weight of the free-flowing aqueous composition.

Glycerol is a trihydric alcohol (IUPAC name 1,2,3-propanetriol) having the empirical formula CH₂(OH)CH(OH)CH₂(OH). Glycerol can be produced by petrochemical means from propene via the allyl chloride and epichlorohydrin intermediates. Preference is given to using crude glycerol in the free-flowing aqueous composition. Crude glycerol shall be understood in the context of the present invention to mean all mixtures comprising glycerol, water, inorganic salts and possibly organic compounds other than glycerol. Preference is given to crude glycerol which is obtained from natural fats or oils. Glycerol is a constituent of all animal and vegetable fats/oils. Crude glycerol is obtained in large volumes as a by-product of biodiesel production. For production of biodiesel, vegetable oils, for example rapeseed oil, are transesterified with methanol. One oil molecule (triacyl glyceride) is reacted with 3 methanol molecules to give glycerol and 3 fatty acid methyl esters. Thus, 10 l of vegetable oil and 1 l of methanol give approx. 10 l of biodiesel and 1 l of crude glycerol. Crude glycerol is thus available inexpensively and in large volumes. Crude glycerol is additionally ecologically and toxicologically safe. The crude glycerol preferably has the following composition:
80 to 90% by weight of glycerol,
10 to 20% by weight of water,
0 to 10% by weight of inorganic salts and
0 to 1% by weight of organic compounds other than glycerol,
   where the percentages by weight are each based on the total weight of the crude glycerol.

Particular preference is given to crude glycerol having the following composition:
80 to 82% by weight of glycerol,
10 to 15% by weight of water,
5 to 7% by weight of sodium chloride and
0.01 to 0.5% by weight of methanol,
   where the percentages by weight are each based on the total weight of the crude glycerol.

The crude glycerol may of course comprise further components which are obtained as impurities in the production of crude glycerol. However, the content of further components in the crude glycerol, is preferably below 1% by weight, more preferably below 0.5% by weight and especially below 0.1% by weight, based in each case on the total weight of the crude glycerol.

Crude glycerol at 20° C. has a density in the range from 1.23 to 1.27 g/cm³. The viscosity of crude glycerol at 20° C. is in the range from 80 mPas to 150 mPa·s. The viscosity of the crude glycerol depends on the water content and any inorganic salts present in the crude glycerol. The use of crude glycerol in the free-flowing aqueous compositions has the advantage that this facilitates the injection of the free-flowing aqueous mixture into the well and optionally into the rock surrounding the perforation region. In addition, the addition of glycerol can increase the density of the free-flowing aqueous composition. This may be advantageous since any formation water present in the well can be displaced more easily as a result. This effect is described in detail under the heading “Process for enhancing the production rate of mineral oil and/or natural gas”.

The percentages by weight of the individual components of the free-flowing aqueous compositions are generally selected such that the sum thereof is 100% by weight.

The percentages by weight of water in the free-flowing aqueous composition also include the amount of water which, in the case of use of crude glycerol, is introduced into the free-flowing aqueous composition by the crude glycerol.

Glycerol, preferably crude glycerol, can also be added in the case that the free-flowing aqueous composition comprises polyalkylene glycol or mixtures of polyalkylene glycol and urea.

The present invention thus also provides a free-flowing aqueous composition which comprises 40 to 80% by weight of ammonium nitrate as the oxidizing agent (O) and 10 to 25% by weight of a reducing agent (R), and also 0.05 to 1% by weight of glucan (G), based in each case on the total weight of the free-flowing aqueous composition, the reducing agent (R) comprising 1 to 50% by weight of urea, 1 to 50% by weight of polyalkylene glycol and 1 to 50% by weight of glycerol, based in each case on the total weight of the reducing agent.

In a further embodiment, the free-flowing aqueous composition comprises ammonium perchlorate, sodium perchlorate, potassium perchlorate or mixtures of ammonium perchlorate, sodium perchlorate and potassium perchlorate as the oxidizing agent (O), and urea as the reducing agent (R). Among the perchlorates listed above as the oxidizing agent (O), preference is given to sodium perchlorate. If the free-flowing aqueous composition comprises sodium perchlorate as the oxidizing agent (O) and urea as the reducing agent (R), the free-flowing aqueous composition comprises preferably 10 to 80% by weight of sodium perchlorate, 10 to 80% by weight of urea, 0.05 to 1% by weight of glucan (G) and 9.95 to 59.95% by weight of water, based in each case on the total weight of the free-flowing aqueous composition. The present invention thus also provides a free-flowing aqueous composition which comprises
10 to 80% by weight of sodium perchlorate,
10 to 80% by weight of urea,
0.05 to 1% by weight of glucan (G) and
9.95 to 79.95% by weight of water,
   based in each case on the total weight of the free-flowing aqueous composition.

The initiation of the exothermic reaction of a free-flowing aqueous mixture comprising sodium perchlorate as the oxidizing agent and urea as the reducing agent (R) likewise releases large amounts of heat and volumes of gas. The urea is decomposed in the process to water and carbon dioxide. The reaction additionally gives rise to nitrogen. The heat released in the exothermic reaction, combined with the evolution of gas, removes high-viscosity substances, as described above, from the surrounding rock of the perforation region. This achieves an increase in the production rate of mineral oil and/or natural gas.

If the free-flowing aqueous composition does not comprise any reducing agent (R), the oxidizing agent (O) used is preferably hydrogen peroxide. In that case, the free-flowing aqueous composition preferably comprises 10 to 69.95% by weight of hydrogen peroxide, 0.05 to 1% by weight of glucan (G) and 30 to 89.00% by weight of water, based in each case on the total weight of the free-flowing aqueous composition. The present invention thus also provides a free-flowing aqueous composition which comprises
10 to 69.95% by weight of hydrogen peroxide,
0.05 to 1% by weight of glucan (G) and
30 to 89.90% by weight of water,
   based in each case on the total weight of the free-flowing aqueous composition.

Hydrogen peroxide is commercially available as an aqueous solution optionally comprising stabilizers, for example phosphoric acid. The percentages by weight of water in the free-flowing aqueous composition also include the amount of water which, in the case of use of aqueous hydrogen peroxide solutions, is introduced into the free-flowing aqueous composition by the aqueous hydrogen peroxide solution.

Aqueous hydrogen peroxide solutions are commercially available with a hydrogen peroxide concentration of 3 to 70% by weight, based on the total weight of the aqueous hydrogen peroxide solution. For the inventive free-flowing aqueous composition, preference is given to using aqueous hydrogen peroxide solutions having a hydrogen peroxide content in the range of 30 to 70% by weight of hydrogen peroxide, based on the total weight of the aqueous hydrogen peroxide solution. Hydrogen peroxide decomposes in the presence of catalysts to give water vapor and oxygen. The decomposition is exothermic. The decomposition reaction thus gives rise likewise to large volumes of gas (water vapor and oxygen) and heat. On exothermic decomposition of the hydrogen peroxide in a free-flowing aqueous composition comprising hydrogen peroxide as the oxidizing agent (O), the volumes of gas which form, combined with the heat which arises, likewise lead to dissolution of high-viscosity substances which block the surrounding rock of the perforation region of the well. This again achieves an increase in the production rate of mineral oil and/or natural gas.

For the initiation of the exothermic decomposition of free-flowing aqueous compositions comprising hydrogen peroxide as the oxidizing agent (O), preference is given to using catalysts. Suitable catalysts are, for example, sodium permanganate (NaMnO₄), potassium permanganate (KMnO₄), calcium permanganate (Ca(MnO₄)₂), copper chloride (CuCl₂), iron chloride (FeCl₃) or mixtures of two or more of the above compounds.

To initiate the exothermic decomposition, these catalysts are introduced, for example, in the form of an aqueous solution into the free-flowing aqueous composition in the well. The aqueous solution comprising the catalyst(s) may likewise have an elevated viscosity. This means that thickeners may be added to the aqueous catalyst solution. A preferred thickener in this context is likewise glucan (G).

In a preferred embodiment, a free-flowing aqueous composition already comprising the catalyst is used. The catalyst used for this purpose is coated catalyst granules comprising, as the catalyst component, sodium permanganate, potassium permanganate, calcium permanganate, copper chloride, iron chloride or mixtures of these compounds, and, as the coating, a substance which dissolves gradually in the presence of water and/or hydrogen peroxide.

The present invention thus also provides a free-flowing aqueous composition comprising 10 to 69.95% by weight of hydrogen peroxide, 0.05 to 1% by weight of glucan (G), 0.05 to 5% by weight of coated catalyst granules and 30 to 89.90% by weight of water, based in each case on the total weight of the free-flowing aqueous composition.

The catalyst granules used are preferably sodium or potassium permanganate coated with a polymer which dissolves in the presence of water and/or hydrogen peroxide within a period of 1 to 3 days. The sodium or potassium permanganate subsequently catalyzes the exothermic decomposition of the hydrogen peroxide present in the free-flowing aqueous composition.

The catalyst granules are generally suspended above ground in the free-flowing aqueous composition directly prior to injection of the exothermic reaction (exothermic decomposition) in process step b).

The free-flowing aqueous composition comprising hydrogen peroxide as the oxidizing agent (O) is likewise environmentally safe. This composition additionally has the advantage that, when used in wells comprising formation water, mixing of the free-flowing aqueous composition with the formation water present in the well can be effectively prevented. As a result, the concentration of the free-flowing aqueous composition remains constant, such that initiation of the exothermic decomposition can be reliably ensured.

In the case of the above-described free-flowing aqueous compositions, particular preference is given to free-flowing aqueous compositions comprising at least one reducing agent (R). Among the oxidizing agents (O), preference is given to ammonium nitrate and sodium perchlorate, and particular preference to ammonium nitrate.

The free-flowing composition (FC) comprises a glucan (G) as a thickener. Preferably, the glucan (G) comprises a main chain composed of β-1,3-glycosidically linked glucose units and pendant groups composed of glucose units β-1,6-glycosidically bonded thereto. The pendant groups preferably consist of a single β-1,6-glycosidically attached glucose unit, with a statistical average of every third unit of the main chain β-1,6-glycosidically bonded to a further glucose unit. Particular preference is given to schizophyllan.

Schizophyllan has a structure according to the formula (I) where n is a number in the range from 7000 to 35 000.

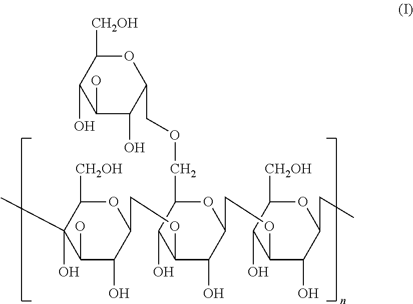

The glucans (G) used in accordance with the invention are secreted by fungal strains. Such fungal strains which secrete glucans (G) are known to those skilled in the art. Preferably, the fungal strains are selected from the group consisting of Schizophyllum commune, Sclerotium rolfsii, Sclerotium glucanicum, Monilinia fructigena, Lentinula edodes and Botrytis cinera. Suitable fungal strains are additionally mentioned, for example, in EP 271 907 A2 and EP 504 673 A1. More preferably, the fungal strains used are Schizophyllum commune or Sclerotium rolfsii and most preferably Schizophyllum commune. This fungal strain secretes a glucan (G) in which a statistical average of every third unit of the main chain is β-1,6-glycosidically bonded to a further glucose unit in a main chain composed of β-1,3-glycosidically bonded glucose units; in other words, the glucan (G) is preferably that called schizophyllan.

The fungal strains are fermented in a suitable aqueous medium or nutrient medium. The fungi secrete the abovementioned glucans (G) into the aqueous medium in the course of fermentation.

Methods for fermenting the abovementioned fungal strains are known in principle to those skilled in the art, for example from EP 271 907 A2, EP 504 673 A1, DE 40 12 238 A1, WO 03/016545 A2 and Udo Rau, “Biosynthese, Produktion and Eigenschaften von extrazellularen Pilz-Glucanen” [Biosynthesis, Production and Properties of Extracellular Fungal Glucans], Habilitation Thesis, Technical University of Braunschweig, 1997. Each of these documents also describes suitable aqueous media or nutrient media.

The glucan (G) which has a β-1,3-glycosidically linked main chain and β-1,6-glycosidically bonded side groups and is present in accordance with the invention in the free-flowing aqueous composition can be produced, for example, by the process described in WO 2011/082973.

The glucan (G) used in accordance with the invention preferably has a weight-average molecular weight M_{W} of 1.5*10⁶ to 25*10⁶ g/mol preferably in the range from 5*10⁶ to 25*10⁶ g/mol. The present invention thus also provides a free-flowing aqueous composition in which the glucan (G) has a weight-average molecular weight M_{W} in the range from 1.5*10⁶ to 25*10⁶ g/mol.

The free-flowing aqueous compositions may additionally optionally comprise further thickeners. Examples of suitable further thickeners include synthetic polymers, for example polyacrylamide or copolymers of acrylamide and other monomers, especially monomers having sulfonic acid groups, and polymers of natural origin, for example glycosyl, other glucans, xanthan or diutans. The use of further thickeners is not absolutely necessary. In one embodiment, the free-flowing aqueous compositions do not comprise any further thickener. The glucan (G) used in accordance with the invention has the advantage that the viscosity of the free-flowing aqueous composition is stable even at relatively high temperatures, for example temperatures greater than 60°. In addition, the free-flowing aqueous compositions are also stable with respect to formation water having a high salt content.

As a result, it is also possible to use the inventive free-flowing aqueous compositions in underground deposits at great depth having high temperatures, for example even temperatures above 100° C. In addition, it is also possible to use the inventive free-flowing aqueous compositions in wells containing formation water having a high salt content. The stable viscosity of the free-flowing aqueous compositions minimizes mixing of these compositions with formation water present in the well. This minimally alters the concentration of the free-flowing aqueous compositions, and so the initiation of the exothermic reaction or of the exothermic decomposition can be reliably ensured. The stable viscosity additionally prevents the sedimentation of any solid constituents present in the free-flowing aqueous composition.

The free-flowing aqueous compositions may additionally comprise at least one surface-active component (surfactant). If the free-flowing aqueous composition comprises a surface-active component, it is preferably present in concentrations of 0.1 to 5% by weight, more preferably 0.5 to 1% by weight, in the free-flowing aqueous composition, based in each case on the total weight of the free-flowing aqueous composition.

The surface-active components used may be anionic, cationic and nonionic surfactants.

Commonly used nonionic surfactants are, for example, ethoxylated mono-, di- and trialkylphenols, ethoxylated fatty alcohols and polyalkylene oxides. In addition to the unmixed polyalkylene oxides, preferably C₂-C₄-alkylene oxides and phenyl-substituted C₂-C₄-alkylene oxides, especially polyethylene oxides, polypropylene oxides and poly(phenylethylene oxides), particularly block copolymers, especially polymers having polypropylene oxide and polyethylene oxide blocks or poly(phenylethylene oxide) and polyethylene oxide blocks, and also random copolymers of these alkylene oxides, are suitable. Such alkylene oxide block copolymers are known and are commercially available, for example, under the Tetronic and Pluronic names (BASF).

Typical anionic surfactants are, for example, alkali metal and ammonium salts of alkyl sulfates (alkyl radical: C₈-C₁₂)) of sulfuric monoesters of ethoxylated alkanols (alkyl radical: C₁₂-C₁₈) and ethoxylated alkylphenols (alkyl radicals: C₄-C₁₂), and of alkylsulfonic acids (alkyl radical: C₁₂-C₁₈).

Suitable cationic surfactants are, for example, the following salts having C₆-C₁₈-alkyl, alkylaryl or heterocyclic radicals: primary, secondary, tertiary or quaternary ammonium salts, pyridinium salts, imidazolinium salts, oxazolinium salts, morpholinium salts, propylium salts, sulfonium salts and phosphonium salts. Examples include dodecylammonium acetate or the corresponding sulfate, disulfates or acetates of the various 2-(N,N,N-trimethylammonium)ethylparaffin esters, N-cetylpyridinium sulfate and N-laurylpyridinium salts, cetyltrimethylammonium bromide and sodium laurylsulfate.

The use of surface-active components in the free-flowing aqueous composition lowers the surface tension of the free-flowing aqueous composition. This allows the free-flowing aqueous composition to more easily fill the perforation region of the well. The use of surface-active components is not absolutely necessary. In one embodiment, the free-flowing aqueous composition does not comprise any surface-active component.

The free-flowing aqueous composition generally has viscosities in the range from 100 to 1500 mPa*s, preferably in the range from 200 to 1000 mPa*s and more preferably in the range from 300 to 800 mPa*s. The viscosities reported were measured on a rotary viscometer (Physica MCR 301) under shear stress control with double slit geometry (PG35-PR-A1) at a shear rate of 7 s⁻¹.

The present invention thus also provides a free-flowing composition having a viscosity in the range from 100 to 1500 mPa*s, preferably in the range from 200 to 1000 mPa*s and more preferably in the range from 300 to 800 mPa*s.

“Free-flowing” in the present context means that the free-flowing aqueous composition can be introduced into the at least one well by pumping.

Process for Enhancing the Production Rate of Mineral Oil and/or Natural as from an Underground Deposit

The above-described free-flowing aqueous compositions can be used to enhance the production rate of mineral oil and/or natural gas from underground deposits comprising mineral oil and/or natural gas.

The present invention thus also provides a process for enhancing the production rate of mineral oil and/or natural gas from an underground deposit comprising mineral oil and/or natural gas, into which at least one well has been sunk, the latter being in contact with the underground deposit through at least one perforation region, comprising at least the following process steps:
a) injecting at least one free-flowing aqueous composition according to any of claims 1 to 10 through at least one well into the perforation region,
b) initiating an exothermic reaction of the free-flowing aqueous composition in the perforation region and
c) restarting the production of mineral oil and/or natural gas from the underground deposit through at least one well.

The process according to the invention is particularly suitable for use in wells comprising formation water. Formation water, also called deposit water, is understood in the present context to mean water present in the well or deposit. This may be water originally present in the underground formation. Formation water in the present context is also understood to mean the water which may have been introduced in a previous step into the underground deposit, for example in the course of secondary or tertiary production processes. The terms “mineral oil” and “natural gas” in the present context do not of course mean pure hydrocarbons. The mineral oil or the natural gas may of course also comprise further substances as well as hydrocarbons. Further substances may, for example, be sulfur-containing hydrocarbons or formation water.

At least one well has been sunk into the underground deposit in which the process according to the invention is employed. This means that exactly one well may be sunk into the underground deposit. However, it is also possible that two or more wells may have been sunk into the underground deposit. The well is in contact with the underground deposit via at least one perforation region.

The wells may each have exactly one perforation region. However, it is also possible that the wells have two or more perforation regions.

The sinking of at least one well into the underground deposit is effected by conventional methods known to those skilled in the art and is described, for example in EP 0 952 300. The well may be a quasi-vertical well, a quasi-horizontal well or a directional well. Directional wells comprise a quasi-vertical and a quasi-horizontal section, the quasi-vertical and the quasi-horizontal section being connected to one another by a curved part. Preferably at least one directional well has been sunk into the underground deposit, preferably into a productive stratum of the underground deposit, the angle of inclination of the quasi-horizontal section of the well following the angle of inclination of the productive stratum of the underground deposit. A productive stratum in the present context is understood to mean the stratum of the underground deposit in which mineral oil and/or natural gas is stored. Productive strata are typically surrounded by dense, substantially impermeable rock.

The length of the quasi-vertical section of the well may vary within wide ranges and depends on the position of the underground deposit, more particularly on the position of the productive stratum. The length of the quasi-vertical section of the well is generally in the range from 100 to 10 000 m, preferably in the range from 100 to 4000 m, more preferably in the range from 100 to 2000 m.

The length of the quasi-horizontal section of the well likewise depends on the position of the underground deposit, more particularly on the position of productive stratum, and may vary within wide ranges. The length of the quasi-horizontal section of the well is generally in the range from 200 to 10 000 m, preferably in the range from 200 to 5000 m and more preferably in the range from 200 to 3000 m.

The perforation region is preferably in the quasi-horizontal section of the well. The length of the perforation region may likewise vary within wide ranges. The length of the perforation region is generally between 10 and 500 m, preferably between 50 and 100 m.

The deposit temperature of the underground deposit comprising mineral oil and/or natural gas is typically in the range from 30 to 150° C., preferably in the range from 70 to 150° C. and more preferably in the range from 80 to 140° C.

In process step a), at least one free-flowing aqueous composition is injected into the perforation region through at least one well.

In a preferred embodiment, prior to the injection of at least one free-flowing aqueous composition in process step a), a free-flowing tamping composition (3) is preferably first introduced into the region of the well bottom of the well. The region of the well bottom of the well is understood to mean the zone directly adjoining the well bottom. The length of the region of the well bottom is generally 0 to 100 m, preferably 0 to 10 m and more preferably 0 to 5 m.

The free-flowing tamping composition (3) used is preferably a composition whose viscosity is a factor of 10 to 500 times higher than the viscosity of the formation water (10) present in the well. The viscosity of the free-flowing tamping composition (3) is typically in the range from 100 to 1500 mPa*s, preferably in the range from 200 to 1000 mPa*s and more preferably in the range from 300 to 800 mPa*s, in each case assuming that the viscosity of the free-flowing tamping composition (3) is higher by a factor of 10 to 500 times than the viscosity of the formation water (10) present in the well. Preferred free-flowing tamping compositions (3) are liquids, solutions or mixtures which are hydrophobic, have poor miscibility with water and have a density higher than the density of the formation water.

The viscosity of the free-flowing tamping composition (3) is preferably likewise adjusted by a thickener, preferably by glucan (G). The free-flowing tamping composition used may also be glycerol, preferably crude glycerol, which may have been thickened with glucan (G). The present invention thus also provides a process in which the free-flowing tamping composition (3) has a viscosity 10 to 500 times higher than the viscosity of the formation water.

As a result of the elevated viscosity of the free-flowing tamping composition (3), formation water (10) present in the well is displaced in a piston-like manner from the region of the well bottom in the direction of the well head (called “piston displacement”). After the free-flowing tamping composition (3) has been introduced, the free-flowing aqueous composition (4) is subsequently likewise introduced into the region of the well bottom. The viscosity of the free-flowing composition (4) is preferably adjusted such that the free-flowing aqueous composition (4) has a viscosity higher by a factor of 1.1 to 5 than the viscosity of the free-flowing tamping composition (3). The present invention thus also provides a process wherein the free-flowing aqueous composition (4) has a viscosity 1.1 to 5 times higher than the viscosity of the free-flowing tamping composition (3).

As a result, the free-flowing aqueous composition (4) displaces the free-flowing tamping composition (3) in the direction of the well head, the free-flowing tamping composition (3) in turn displacing the formation water (10) present in the well, likewise in the direction of the well head.

After the injection of the at least one free-flowing aqueous composition (4), a further free-flowing tamping composition (5) can subsequently likewise be injected into the region of the well bottom of the well. For the further free-flowing tamping composition (5), the above details regarding the free-flowing tamping composition (3) apply correspondingly. The viscosity of the further free-flowing tamping composition (5) may correspond to the viscosity of the free-flowing tamping composition (3). The viscosity of the further free-flowing tamping composition (5) is preferably adjusted such that the viscosity is higher by a factor of 1.1 to 5 times than the viscosity of the free-flowing aqueous composition (4). The present invention thus also provides a process wherein the further free-flowing tamping composition (5) has a viscosity 1.1 to 5 times higher than the viscosity of the free-flowing aqueous composition (4).

As a result, the further free-flowing tamping composition (5) displaces the free-flowing aqueous composition (4) in the direction of the well head, and the free-flowing aqueous composition (4) in turn displaces the free-flowing tamping composition (3) in the direction of the well head, and this in turn displaces the formation water (10) in the direction of the well head.

In a preferred embodiment, the free-flowing tamping composition (3), the free-flowing aqueous composition (4) and the further free-flowing tamping composition (5) are introduced into the region of the well bottom via a pipe run (coil tubing). In a particularly preferred embodiment, during the introduction of the free-flowing tamping composition, the free-flowing composition and the free-flowing further tamping composition, the coil tubing is not moved.

The free-flowing aqueous composition (4) is positioned along the well of the perforation zone. This minimizes the probability of damage to the stabilized region of the well (casing).

“Free-flowing” in the present context means that the free-flowing tamping composition (3) and the further free-flowing tamping composition (5) can be introduced into the at least one well by pumping.

The present invention thus also provides a process for enhancing the production rate of mineral oil and/or natural gas from an underground deposit comprising mineral oil and/or natural gas, into which at least one well has been sunk, the latter being in contact with the underground deposit through at least one perforation region, comprising at least the following process steps:
a) injecting at least one free-flowing aqueous composition into the perforation region through at least one well.
b) initiating an exothermic reaction of the free-flowing aqueous composition in the perforation region and
c) restarting the production of mineral oil and/or natural gas from the underground deposit through at least one well,
   process step a) being preceded by introduction of a free-flowing tamping composition (3) via a coil tubing (2) into the region of the well bottom of the well, as a result of which formation water (10) present in the well is displaced in the direction of the well head, and the injection of the at least one free-flowing aqueous composition (4) according to process step a) being effected via the same coil tubing (2), likewise into the region of the well head of the well, as a result of which the free-flowing tamping composition (3) and the formation water (10) present in the well are displaced in the direction of the well head, and, after process step a), a further free-flowing tamping composition (5) being introduced via the same coil tubing (2) likewise into the region of the well bottom of the well, as a result of which the free-flowing aqueous composition (4), the free-flowing tamping composition (3) and the formation water (10) present in the well are displaced in the direction of the well head.

Thus, at least three portions of the free-flowing compositions are injected serially into the well with rising viscosity. If long horizontal wells are being treated, in order to reduce the frictional forces in the course of injection, the above-described crude glycerol can be added to all three portions. It is also possible to use other substances with good lubrication properties.

The exothermic reaction in process step b) is initiated by an electrical or chemical detonator. An example of a suitable electrical detonator is a light arc detonator. The chemical detonator used is preferably a combination of aqueous acid and magnesium granules.

To this end, for example, magnesium granules can be introduced into the well in the form of an aqueous suspension and subsequently mixed with aqueous acid in the well. This forms a detonation mixture in the well, said mixture comprising magnesium granules and aqueous acid.

The aqueous acid used may, for example, be an aqueous hydrochloric acid solution having a hydrochloric acid content in the range from 1 to 38% by volume, preferably in the range from 10 to 25% by volume and more preferably in the range from 15 to 20% by volume. The chemical detonation mixture is preferably likewise introduced into the well via the coil tubing (2). The chemical detonation mixture is preferably introduced into the region of the well filled with the free-flowing aqueous composition (4). The perforation region of the well has preferably been filled with the free-flowing aqueous composition (4).

The reaction of hydrochloric acid with magnesium gives hydrogen and heat, according to the following reaction equation:

2HCI+Mg→MgCl₂+H₂+heat.

The chemical reaction of one kilogram of magnesium with hydrochloric acid generates approx. 5000 kcal of heat, and the temperature of the chemical detonation mixture reaches 300 to 600° C. This temperature initiates the exothermic reaction of the free-flowing aqueous composition in process step b).

It is also possible to initiate the exothermic reaction in process step b) by means of a light arc detonator. The light arc detonator is preferably likewise introduced into the region of the well filled with the free-flowing aqueous composition (4) via the coil tubing (2).

If a free-flowing composition (4) comprising hydrogen peroxide as the oxidizing agent (O) is used, the exothermic reaction, i.e. in this case the exothermic decomposition, can likewise be initiated by means of a chemical detonator or a light arc detonator. Preference is given, however, to initiating the exothermic decomposition by the introduction of catalysts. Suitable catalysts for initiation of the exothermic decomposition have been described above for the free-flowing aqueous compositions (4). The catalysts are introduced, for example, in the form of an aqueous solution via the coil tubing (2) into the region of the well filled with the aqueous free-flowing composition (4) comprising hydrogen peroxide as the oxidizing agent (O).

The free-flowing aqueous composition preferably comprises the catalyst in the form of coated catalyst granules.

After the exothermic reaction has finished, the production of mineral oil and/or natural gas is restarted according to process step c). The production is effected by conventional methods.

The invention is illustrated by the figures and examples which follow, without being restricted thereto.

The reference numerals in the present context are defined as follows:
1 quasi-horizontal well
11 quasi-vertical well
2 pipe run (coil tubing)
3 free-flowing tamping composition
4 free-flowing aqueous composition
5 further free-flowing tamping composition
6 perforation region of the well 1 or 11
10 formation water

The individual figures show:

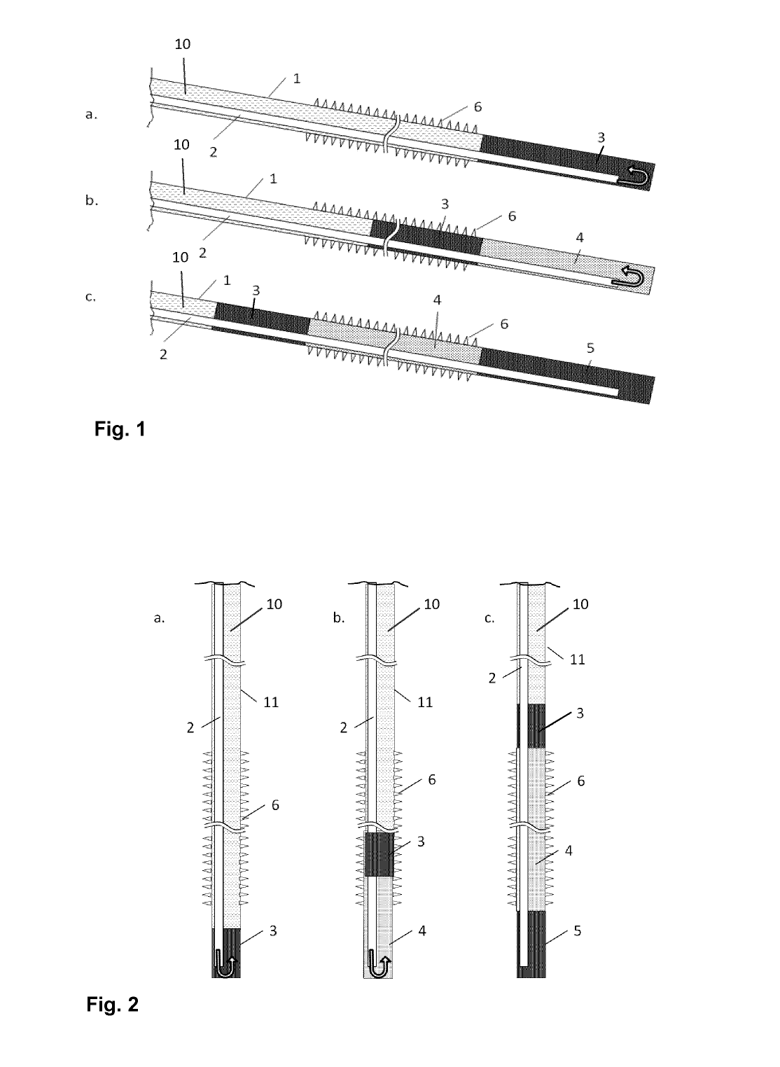

FIGS. 1A, 1B and 1C

Phases of the injection of the free-flowing aqueous composition into the perforation region 6 of the quasi-horizontal well 1,

FIGS. 2A, 2B and 2C

Phases of the injection of the free-flowing aqueous composition into the perforation region 6 of the quasi-vertical well 11.

FIGS. 1A-1C show a vertical section through an underground deposit which comprises mineral oil and/or natural gas, and into which a quasi-horizontal well 1 has been sunk. The underground deposit is in contact with the well 1 via the perforation region 6. Mineral oil and/or natural gas flows from the underground deposit into the quasi-horizontal well 1 via the perforation region 6. The perforation region is surrounded by rock strata having fissures and cracks. The perforation region 6 is blocked by the deposition of high-viscosity substances. This blockage leads to a reduction in the production rates of mineral oil and/or natural gas. Formation water 10 is present in the quasi-horizontal well 1. In FIG. 1A, a coil tubing 2 was introduced into the region of the well bottom. In FIG. 1A, the tamping composition 3 is first injected through the coil tubing 2 into the region of the well bottom of the quasi-horizontal well 1. As a result, the tamping composition 3 displaces the formation water 10 present in the quasi-horizontal well 1 in the direction of the well head. As shown in FIG. 1B, subsequently the free-flowing composition 4 is injected through the same coil tubing into the region of the well bottom. The free-flowing composition 4 displaces the tamping composition 3, which in turn displaces the formation water 10 present in the well 1 in the direction of the well head. In FIG. 10, a further tamping composition 5 is injected into the region of the well bottom via the same coil tubing. The further tamping composition 5 displaces the free-flowing aqueous composition 4 in the direction of the well head. The amount of the further tamping composition 5 is selected such that the free-flowing aqueous composition 4 fills the perforation region 6. As a result of the displacement of the free-flowing aqueous composition 4, it in turn displaces the free-flowing tamping composition 3, which in turn displaces the formation water 10 in the direction of the well head.

FIGS. 2A, 2B and 2C differ from FIGS. 1A, 1B and 10 in that the free-flowing tamping composition 3, the free-flowing aqueous composition 4 and the further free-flowing tamping composition 5 are introduced into a quasi-vertical well 11 having a perforation region 6.

### Example

In the course of development of an underground deposit at a depth of approx. 2000 m in the offshore sector, a production well was sunk into the underground deposit from a production platform. The well is a directional well. The quasi-horizontal part of the well is 2 to 4 km in length. The final section of the quasi-horizontal part of the production well has been perforated. The length of the perforation regions is 100 m. Mineral oil and/or natural gas was produced from the underground deposit for a period of 1 to 10 years through the production well. After this time, a significant reduction in the production rates of mineral oil and/or natural gas from the underground deposit occurs. The reduction in the production rate is caused by the deposition of high-viscosity substances in the rock surrounding the perforation region of the quasi-horizontal part of the well.

The quasi-horizontal part of the well has an unperforated final section and a perforation region. The internal diameter of the well is 0.127 m. The unperforated final section of the well is 70 m in length. The subsequent perforation region has a length of 100 m.

To increase the production rate of mineral oil and/or natural gas from the underground deposit, a coil tubing having an internal diameter of 20 mm is first introduced into the well, down to the well bottom. Subsequently, the tamping composition is introduced through the coil tubing into the region of the well bottom. A volume of 1 m³ with a viscosity of 400 mPa*s is injected here. Subsequently, without a wait period and without purging the coil tubing, the inventive free-flowing aqueous composition is injected through the coil tubing. A free-flowing aqueous composition which comprises ammonium nitrate as the oxidizing agent (O) and urea as the reducing agent (R), and also water, and has been thickened with glucan (G) is used here. The viscosity of the free-flowing aqueous composition is 500 mPa*s. The volume injected is 1.5 m³. Subsequently, the further tamping composition is likewise injected through the same coil tubing into the region of the well bottom. The further tamping composition has a viscosity of 600 mPa*s. The volume of the further tamping composition injected is 1 m³.

Thus, a total of 3.5 m³ of liquids are injected into the quasi-horizontal part of the well. The free-flowing tamping composition, the free-flowing aqueous composition and the further free-flowing tamping composition mix only to a minimal extent within the coil tubing or within the well.

After the performance of the above process steps, there are four liquid columns within the well. Beginning from the side of the well bottom, these are 70 m of the further tamping composition, 100 m of the free-flowing aqueous composition and 70 m of the tamping composition and formation water.

Subsequently, the exothermic reaction of the free-flowing aqueous composition is initiated by means of an electrical or chemical detonator. At the end of the exothermic reaction, the production of mineral oil and/or natural gas is restarted.

1.-15. (canceled)

16. A free-flowing aqueous composition comprising
at least one oxidizing agent (O) selected from the group consisting of ammonium nitrate, ammonium perchlorate, sodium perchlorate, potassium perchlorate and hydrogen peroxide,
at least one reducing agent (R) selected from the group consisting of urea, polyalkylene glycol and glycerol, and
a glucan (G) having a β-1,3-glycosidically linked main chain and side groups β-1,6-glycosidically bonded thereto.

17. The free-flowing aqueous composition according to claim 16, wherein the glucan (G) has a weight-average molecular weight M_{W} in the range from 1.5*10⁶ to 25*10⁶ g/mol.

18. The free-flowing aqueous composition according to claim 16, which comprises 10 to 80% by weight of at least one oxidizing agent (O),
10 to 80% by weight of at least one reducing agent (R),
0.05 to 1% by weight of glucan (G) and
5 to 79.95% by weight of water,
based in each case on the total weight of the free-flowing aqueous composition.

19. The free-flowing aqueous composition according to claim 16, which comprises
40 to 80% by weight of ammonium nitrate,
10 to 25% by weight of urea,
0.05 to 1% by weight of glucan (G) and
9.95 to 49.95% by weight of water,
based in each case on the total weight of the free-flowing aqueous composition.

20. The free-flowing aqueous composition according to claim 16, which comprises
40 to 80% by weight of ammonium nitrate,
10 to 25% by weight of polyalkylene glycol,
0.05 to 1% by weight of glucan (G) and
9.95 to 49.95% by weight of water,
based in each case on the total weight of the free-flowing aqueous composition.

21. The free-flowing aqueous composition according to claim 16, which comprises
40 to 80% by weight of ammonium nitrate,
5 to 25% by weight of urea,
5 to 10% by weight of glycerol,
0.05 to 1% by weight of glucan (G) and
9.95 to 49.95% by weight of water,
based in each case on the total weight of the free-flowing aqueous composition.

22. The free-flowing aqueous composition according to claim 16, which comprises
10 to 80% by weight of sodium perchlorate,
10 to 80% by weight of urea,
0.05 to 1% by weight of glucan (G) and
9.95 to 79.95% by weight of water,
based in each case on the total weight of the free-flowing aqueous composition.

23. The free-flowing aqueous composition according to claim 16, wherein the free-flowing aqueous composition comprises
40 to 80% weight of ammonium nitrate as a oxidizing agent (O),
10 to 25% by weight of a reducing agent (R) and
0.05 to 1% by weight of glucan (G) an,
based in each case on the total weight of the free-flowing aqueous composition,
wherein the reducing agent (R) comprises 1 to 50% by weight of urea and 1 to 50% by weight of polyalkylene glycol, based in each case on the total weight of the reducing agent (R).

24. The free-flowing aqueous composition according to claim 23, wherein the reducing agent (R) additionally comprises 1 to 50% by weight of glycerol, based on the total weight of the reducing agent (R).

25. The free-flowing aqueous composition according to claim 16, which has a viscosity in the range from 100 to 1500 mPa*s, preferably in the range from 200 to 1000 mPa*s and more preferably in the range from 300 to 800 mPa*s.

26. A process for enhancing the production rate of mineral oil and/or natural gas from an underground deposit comprising mineral oil and/or natural gas, into which at least one well has been sunk, the latter being in contact with the underground deposit through at least one perforation region, comprising at least the following process steps:
a) injecting at least one free-flowing aqueous composition according to claim 1 through at least one well into the perforation region,
b) initiating an exothermic reaction of the free-flowing aqueous composition in the perforation region and
c) restarting the production of mineral oil and/or natural gas from the underground deposit through at least one well.

27. The process according to claim 26 in which, prior to process step a), a free-flowing tamping composition is introduced via a coil tubing into the region of the well bottom of the well, as a result of which formation water present in the well is displaced in the direction of the well head, and the injection of the at least one free-flowing aqueous composition according to process step a) is effected via the same coil tubing, likewise into the region of the well head of the well, as a result of which the free-flowing tamping composition and the formation water present in the well are displaced in the direction of the well head, and, after process step a), a further free-flowing tamping composition is introduced via the same coil tubing likewise into the region of the well bottom of the well, as a result of which the free-flowing aqueous composition, the free-flowing tamping composition and the formation water present in the well are displaced in the direction of the well head.

28. The process according to claim 27 in which the free-flowing tamping composition has a viscosity 10 to 500 times higher than the viscosity of the formation water.

29. The process according to claim 26, wherein the free-flowing aqueous composition has a viscosity 1.1 to 5 times higher than the viscosity of the free-flowing tamping composition.

30. The process according to claim 27, wherein the further free-flowing tamping composition has a viscosity 1.1 to 5 times higher than the viscosity of the free-flowing aqueous composition.
